(19) United States
(12) Patent Application Publication
(10) Pub. No.: US 2007/0043593 A1
(43) Pub. Date: Feb. 22, 2007

(54) Multiple account updates in a practice management system

(76) Inventors: Wayne A. Provost, Salt Lake City, UT (US); Ryan M. Trimble, Laguna Hills, CA (US); Kevin Phillips, Salt Lake City, UT (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 11/205,863

(22) Filed: Aug. 17, 2005

(51) Int. Cl. G06Q 10/00; G06Q 40/00

(52) U.S. Cl. 705/2; 705/4

(57) ABSTRACT

An electronic practice management system can be configured to send batch update requests to one or more payors (e.g., insurers) of one or more pending claims for healthcare service. In one implementation, a practice management system responds to a request for an update to one or more claims. The system then generates a batch update request message that has a batch identifier, and may be directed to one or more payors. Responses to the batch update message are then processed by the practice management system, and then provided as appropriate upon request to the healthcare provider. The healthcare provider can request the updates automatically from multiple payors in future batch requests based on a predetermined time interval. The system can also communicate with one or more banks to identify specific information regarding claim payment.

### CROSS-REFERENCE TO RELATED APPLICATIONS

Not Applicable.

### BACKGROUND OF THE INVENTION

1. The Field of the Invention

This invention relates to systems, methods, and computer program products regarding healthcare practice management systems.

2. Background and Relevant Art

Healthcare costs and related payment plans are increasingly complicated, whether from the perspective of the patient, the health care provider, or from the payor (i.e., patient, insurer, or other third party). From the time the patient enters a facility and receives care from the health care provider, a large number of forms may be filled out and passed around. These forms may document what care was received, who the patient saw, where the patient was seen, the services performed, and any full or partial payments made or anticipated to be made by the patient or relevant payor. Other forms may be used to document prior pricing recommendations from the payor, disputes regarding amount of requested payments, as well as payment timelines.

One can appreciate, therefore, that it can be a fairly complicated matter for the health care provider to balance all relevant payments and claims from (or sent to) all relevant parties with respect to any number of patient accounts. For example, when a patient arrives at a healthcare facility, the patient will often provide some form of third-party payor (e.g., insurance carrier) information, which will ultimately be used to satisfy a balance on the patient's account. In those cases, the health care provider will typically document what the patient already paid, if anything, post that to the patient's account, and then send a corresponding claim for any remaining amount to the identified payor. The healthcare provider, or relevant healthcare staff, will then check the status of claims over some predetermined period of time. For example, the healthcare provider might receive claim reports from different insurers, and review what claims have been paid in full or in part, and which claims are still pending. The healthcare provider might then sort the claim reports to see which claims still have outstanding amounts after 30 days, 60 days, 90 days, and so on.

Recently, some electronic practice management systems (“PMS”) enable healthcare providers to handle much of the claim and remittance transactions through electronic fund transfers and electronic claim forms. In particular, the federal Health Insurance Portability and Accountability Act (HIPAA) requires that third-party electronic payment information is formatted for one type of standardized electronic message, and that claims be submitted in another type of electronic format message. That is, the healthcare provider submits a standardized electronic claim file to an insurer, and the insurer can pay those claims via an electronic fund transfer using another standardized electronic message. These standardized messages can be tagged with different fields to denote appeals, recommendations, or other information as appropriate. There are many different types of standard electronic documents that can be transmitted back and forth between the healthcare provider and insurers.

Unfortunately, there is presently no convenient way for healthcare providers to monitor the status of claims that have been submitted to several different insurers. For example, a healthcare provider may have multiple claims that have not been paid within a certain time interval. In addition, these claims may have been sent to different insurers. To check the status (e.g., inquire/resolve) of each of these claims, the healthcare provider will need to write or call each insurer individually, and then ask about the status of each individual claim. While discussing claims with an agent over the telephone may be more efficient than written inquiries in some cases, the healthcare provider may be limited in some cases to inquiring only on a specific number of claims for a single session with an agent. For example, if the insurer only allows three claim inquiries in a single telephone session, and the healthcare provider has six claims submitted with the given insurer, the healthcare provider might need to make two separate telephone calls to insurance call agents to resolve all pending claims.

Other inquiries, such as electronic inquiries, can also be inefficient. For example, the healthcare provider with several claims pending with several different insurers might need to make a new, separate electronic inquiry for each claim and each given insurer through the practice management system. The practice management system might then receive corresponding electronic responses to the inquiries, which the healthcare provider can then review, and determine if a new status update needs to be sent. If a new status update request needs to be sent, the healthcare provider will then need to create a new status update request message through the practice management system again for each claim of interest at each different insurer of interest, and then send the new status update request.

Furthermore, even if the healthcare provider receives information that a claim has been paid through electronic remittance, the healthcare provider will receive a notice from the bank that indicates primarily that funds have been added. This information may also indicate that general finds have been added by a given insurer. Unfortunately, this information does not necessarily inform the healthcare provider what claims, if any, the added funds were meant to cover. Thus, the healthcare provider may still need to do additional work to match any existing claims and remittance for given patient accounts.

Accordingly, an advantage in the art can be realized with systems, methods, and computer program products that simplify and add efficiency to the management of submitted claims in a healthcare provider remittance system.

### BRIEF SUMMARY OF THE INVENTION

The present invention solves one or more of the problems in the art with systems, methods, and computer program products configured to simplify one or more claim management aspects in a healthcare provider's practice management system. In particular, one implementation of the present invention relates to a healthcare provider managing multiple claims with multiple insurers through electronic batch update messages. Additional implementations of the present invention relate to managing payments from insurers such that payments can be related to full or partial payments of specific claims in specific patient accounts.

For example, one method of managing claims in accordance with an implementation of the present invention involves receiving a request for a status update of one or more claims being handled by one or more payors. For example, the one or more claims may not have been previously settled. The method also involves creating a batch message that requests the status update for each of the one or more claims, where the batch message includes a batch identifier. In addition, the method involves sending the batch message to the one or more payors over a network. As such, each corresponding payor of the one or more payors receives an electronic request for any of the one or more claims previously received by the corresponding payor.

Another method in accordance with an implementation of the present invention involves receiving one or more electronic messages from a bank that funds have been added to one or more accounts of a healthcare provider. The method further involves identifying payor information for the funds that have been added. The payor information can include one or more claim remittance identifiers, such as remittance identifiers included in checks deposited to the bank, which correspond to one or more claims. Thus, the method also involves identifying one or more pending claims that correspond to the one or more claim remittance identifiers. In addition, the method involves updating one or more patient accounts that correspond to the one or more pending claims. As such, an amount of the funds that have been paid on a claim in a patient account can be identified.

Additional features and advantages of exemplary implementations of the invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1A illustrates a schematic diagram in which a practice management system provides for an update request for one or more claims with one or more payors using a batch message in accordance with an implementation of the present invention;

FIG. 1B illustrates a schematic diagram in accordance with an implementation of the present invention in which the batch message illustrated in FIG. 1A can be resent to get one or more corresponding new updates;

FIG. 2 illustrates a schematic diagram in accordance with an implementation of the present invention in which a practice management correlates one or more electronic messages from one or more banks and/or one or more payors to provide claim and claim payment information for a patient account;

FIG. 3 illustrates a flowchart of a method for sending a batch update message through a practice management system in accordance with an implementation of the present invention; and

FIG. 4 illustrates a flowchart of a method for updating one or more patient accounts through one or more messages received from a bank in accordance with an implementation of the present invention.

### DETAILED DESCRIPTION OF THE PREFERRED EMBODIMENTS

The present invention extends to systems, methods, and computer program products configured to simplify one or more claim management aspects in a healthcare provider's practice management system. In particular, one implementation of the present invention relates to a healthcare provider managing multiple claims with multiple insurers through electronic batch update messages. Additional implementations of the present invention relate to managing payments from insurers such that payments can be related to full or partial payments of specific claims in specific patient accounts.

For example, and as will be understood more fully from the following description and claims, a healthcare provider can identify certain claims, such as claims pending with various payors (e.g., insurers). The healthcare provider can then prepare a single electronic batch update message through an electronic healthcare practice management system. The batch update message includes the identifies claims. The batch update message also includes a batch identifier (“ID”), which can be reused for repeat requests on the same pending claims of interest.

The healthcare provider can then receive updates from multiple payors regarding the requested claims, and can correlate this information with payment information received from one or more banks. In one implementation, the healthcare provider correlates the claim update information with claim remittance numbers provided by the be bank when a remittance has been posted to the healthcare provider's account. The healthcare provider can then identify how much remittance has been made for specific claims sent out on behalf of specific patient accounts in the practice management system.

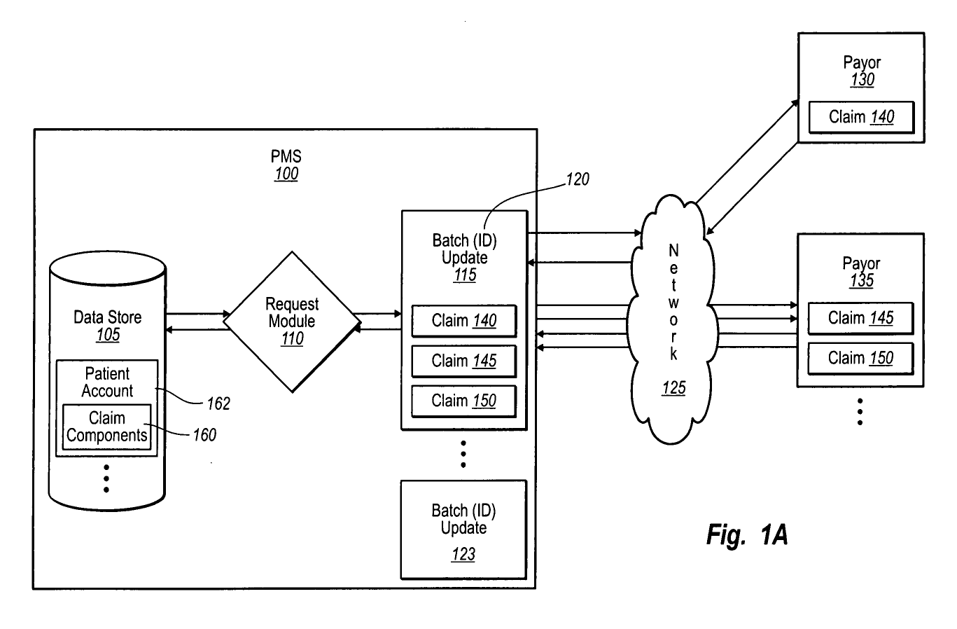

For example, FIG. 1A illustrates a schematic diagram in which a practice management system 100 is used to request claim updates from payors (e.g., an insurer, third-party, or patient, etc.). For example, a healthcare provider reviews patient accounts in the practice management system 100 and identifies that there are a number of claims (represented in this example by the claims 140, 145, and 150) that are still “in process”, or otherwise have not yet been paid. Claims can be selected on other criteria as well such as by time or by aging. The healthcare provider then initiates a corresponding update request of the claims 140, 145, 150. To do so, the healthcare provider can select the claims 140, 145, 150 through a corresponding user interface at a computerized system, and then send an appropriate electronic message to a request module 110 at practice management system 100.

In general, request module 110 comprises any number of computer-executable modules and/or related program components in practice management system 100. In particular, request module 110 can include any program modules and/or related components for interfacing with a data store 105, for interfacing with any other network components and/or communication stack, and for processing related messages. Accordingly, request module 110 is configured in at least one implementation to create appropriate messages that can be sent to one or more payors 130, 135, etc., as well as to receive and process any corresponding response messages from the same.

For example, FIG. 1A shows that request module 110 creates batch update message 115, having a batch ID 120. Batch update message 115 is prepared in response to healthcare provider input, and relates to update requests for claims 140, 145, and 150, which are pending at payors 130 and 135, as shown in this example. Request module 110 can also prepare other batch update messages such as the batch update message 123, which have a separate batch IDs, and relate to still other pending claims with the same or other payors.

Upon preparing batch update message 115, request module 110 sends the message to payors 130 and 135 over network 125. In one implementation, for example, request module 110 sends an identical copy of the batch update message 115 to each payor 130, 135 (and so on, as appropriate), whereby each payor only processes those claim requests that are appropriate for the payor. For example, FIG. 1A shows that claim 140 is pending with payor 130, while claims 145 and 150 are pending with payor 135. In other implementations, request module 110 prepares batch message 115, and then parses the batch message 115 into individual claim update request messages for each of claims 140, 145, 150, etc., and sends each corresponding claim update request only to the appropriate payors. Thus, the payor 130 receives an update request message for the claim 140 while the payor 135 receives update request messages for the claims 145 and 150.

Ultimately, request module 110 can receive responses to the claim update requests, and process them. In one implementation, processing these responses includes parsing such received data to determine whether the claim has been paid, the extent the claim has been paid, whether the claim is being contested, a billing recommendation, or the like or any combination thereof. The request module 110 then correlates this data with, by way of example, the claim components 160 of the relevant patient accounts 162 in data store 105. This allows a healthcare provider to access the patient account in the practice management system through a corresponding interface, and discover the received update information for the requested claims (e.g., 140, 145, and 150).

The process illustrated through FIG. 1A can be configured by any of the healthcare provider, or the practice management system to occur by manual selection or by other automatic processes. For example, in one implementation, the healthcare provider sets the batch update message 115 to occur automatically, such that certain claims are resolved with a predetermined frequency. That is, the healthcare provider can configure a component of the practice management system such that all unresolved claims submitted to any payor by the healthcare provider are culled into a corresponding batch update message (e.g., 115, 123, etc.) every 30 days, every 60 days, or every 90 days, and so on. Thus, the request module 110 can automatically submit an update request message for every occurrence of some predetermined time interval, and then receive corresponding update information for those intervals. The request module 110 can then present the received/processed information to the healthcare provider in a manner that denotes the given request/response interval.

The request module 110 can organize received responses for each given claim, and for each given patient account, such that the healthcare provider views a history for each given claim. In particular, a specific organization of claims, claim update requests, and claim update responses, can be provided through a corresponding user interface via local or remote access. This can allow, for example, the healthcare provider to view, from any location, what claims still remain unresolved after 90 days. If, upon viewing present claim status, or in response to an automatic configuration, certain claims in a prior batch request need to be updated again, the healthcare provider (or other automatic request module) can then reinstitute a prior request through the practice management system.

For example, FIG. 1B illustrates a schematic in which a healthcare provider can institute a new batch update message, and can reinstitute a prior request if appropriate. In particular, FIG. 1B shows that user interface 170 provides present status information 175 about presently pending claims 140, 145, and 150. In general, user interface 170 can be any type of interface provided through practice management system 100 over a network. In one implementation, user interface 170 is simply an active server page (“ASP”) containing information generated at practice management system 100, and sent to a computer system used by the healthcare provider. For example, the healthcare provider opens a network browser, establishes a connection, and logs-in to practice management system 100. Practice management system 100 then responds to any number of requests by retrieving appropriate information from data store 105, formats the information into an appropriate ASP, and sends the ASP to the healthcare provider for processing at the healthcare provider's network browser.

In any event, FIG. 1B shows that user interface 170 provides the ability to select any additional payment details for a given claim, and the ability to make a new request for any updates to these claims. In particular, since an update request has already submitted a batch update for these claims previously (i.e., batch update message 115, FIG. 1A), the user (i.e., healthcare provider) can simply insert a batch ID number into a new message interface 180. For example, FIG. 1B shows that new message interface 180 includes an entry field 185, where the healthcare provider can insert a batch ID from a prior request, such as batch ID 120. The healthcare provider can then select an execution link/function through the user interface.

Upon selection, the healthcare provider's computer system formats any corresponding information associated with the request (in this case, a re-request for batch update message 115) into electronic message 173, and sends message 173 to practice management system 100 over network 125. As with FIG. 1A, request module 110 can then prepare a properly formatted batch update message, such as a message in this case based on previously sent batch update message 115. Request module 110 then sends the update request as appropriate to the payors corresponding to the pending claims. Upon processing a response from the indicated payors, practice management system 100 (via request module 110) can then send one or more appropriately formatted response messages 177 to the healthcare provider's computer system. The healthcare provider can then view the received information through user interface 170.

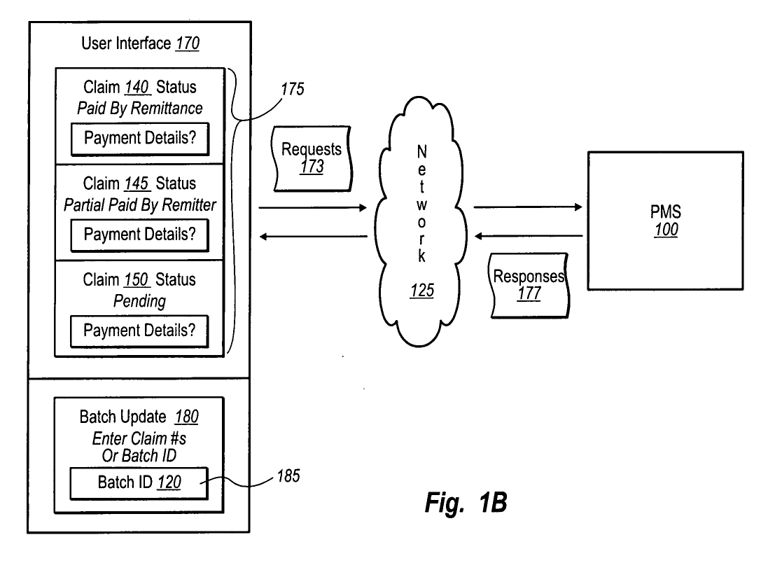

As previously indicated, the updated claim information can include any number of details, such as whether a claim has been paid, how much has been paid on a claim, whether the claim has been settled or is still being contested, or the like. In some cases, this information can be obtained from responses from corresponding payors 130, 135, etc. In other cases, this information may be obtained via information from a bank that manages one or more accounts for the healthcare provider. For example, FIG. 2 shows that the practice management system 100 can be communicatively coupled to various banks (represented in this example by banks 200, 205) over network 125. That is, practice management system 100 can communicate electronically over network 125, such as through a secure link, with banks handling accounts for any healthcare providers. The banks, in turn, receive payments from payors (e.g., payors 130, 135), such as electronic fund transfers, physical presentation of checks, receipt of electronic checks, and the like.

In general, practice management system 100 can be configured with one or more modules or components that are, in turn, configured to “pull” (e.g, request) and/or receive a “push” of information from one or more banks 200, 205, etc. for the given healthcare providers. For example, practice management system 100 can be configured to automatically login and request information regarding recent funding of a given account at a given bank. Alternatively, bank 200 can be configured to automatically login to practice management system 100, and push all funding update data related to any healthcare provider accounts previously requested by system 100. In any event, FIG. 2 shows that practice management system 100 can receive data from any number of banks, as appropriate.

The information received from the banks can include specifically formatted electronic messages that include, for example, the amount of funds added to an account, any check (or other payment method) numbers for those funds, any claim remittance numbers for the funds, or the like. Practice management system 100 can then parse the received data and perform any matching functions with presently pending claims (e.g., claims 140, 145, 150). This enables the practice management system 100 to allocate the funds to the appropriate patient accounts.

For example, an interface or other appropriate module at practice management system 100 can take a message/communication from bank 200, which may include the present amounts of all healthcare provider accounts maintained by bank 200 and/or may include the amounts of all recent payments made to the accounts of the healthcare provider. The message/communication can include all the payments (physical or electronic remittances) and corresponding information associated with each payment. The practice management system then parses the payment information, and matches this information with corresponding information for each pending or settled claim (e.g., remittance numbers received from payors 130, 135 in response to a batch update message 115). Thus, FIG. 2 shows, for example, that claim 140 is associated with remittance 230, and that remittance 230 is associated with both claim 140 and claim 145.

A healthcare provider that logs-in to practice management system 100 (e.g., through user interface 170, or the like) can find relatively detailed information about the extent to which specific claims for prior services have or have not been paid. For example, as previously mentioned, the healthcare provider can identify specific patient accounts, and the extent to which those accounts have been paid, and which payor has sent the corresponding payments for given claims. The healthcare provider can also identify the amount of time specific claims (and specific unpaid portions of claims) remain pending, the check numbers or remittance numbers used to pay those claims in specific time intervals, and so on. Moreover, the healthcare provider can sort pending and paid information for specific accounts to generate new update request messages, as appropriate.

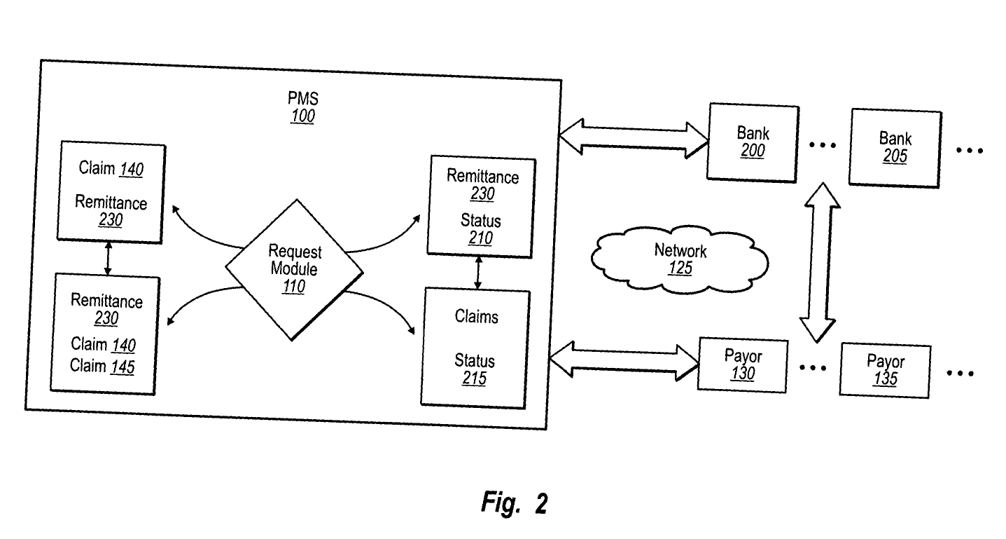

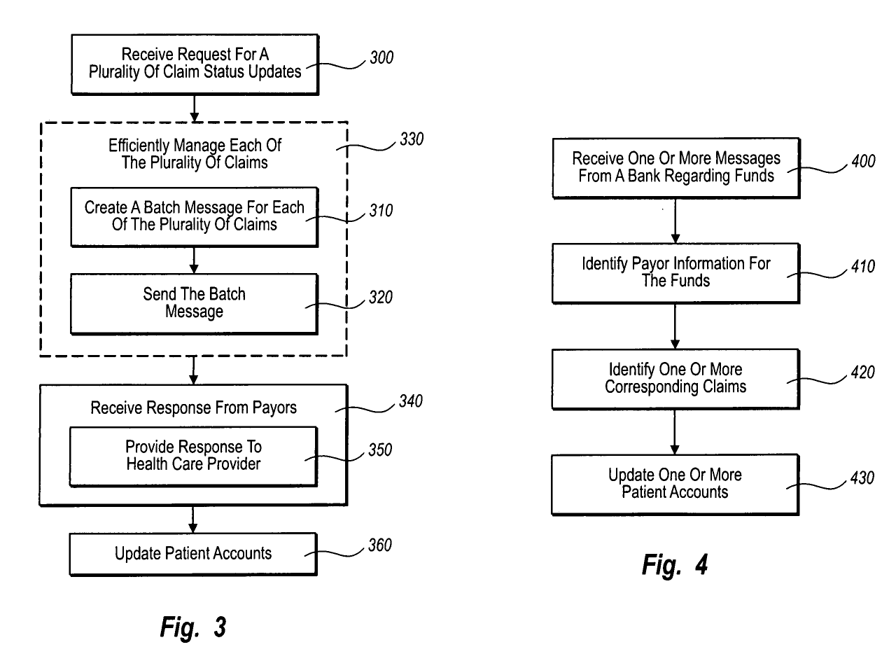

Accordingly, FIGS. 1A through 2 illustrate schematics of how a practice management system can be configured to balance patient accounts and healthcare provider accounts with efficiency and accuracy. Embodiments of the present invention also relate to methods for accomplishing a particular result such as managing or updating patient accounts. FIGS. 3 and 4 illustrate flow charts of methods for sending a batch update message, as well as of receiving bank account information that correlates with one or more claims and/or one or more patient accounts.

For example, FIG. 3 shows that a method for managing claims and claim payments may begin with receiving 300 a request for a claim status update. The request may correspond to multiple claims. Receiving 300 a request for a status update of claims being handled by one or more payor may include receiving a request for a status update of claims that have not been settled or that have been pending for a certain amount of time. For example, a practice management system 100 receives a request from a healthcare provider, such as via an electronic message received through an electronic interface at the healthcare provider's computer system. The request from the healthcare provider includes a request that is processed by request module 110 regarding an update to claims 140, 145, and 150 that are pending with payors 130 and 135.

In addition, FIG. 3 shows that the method further includes managing 330 each of the plurality of claims after receiving a request from a health care provider. Managing 330 each of the claims includes managing each of the claims simultaneously through batch requests and responses. The batch requests and corresponding responses allow a healthcare provider to efficiently update multiple claims pending with multiple payors in an efficient manner without necessarily creating a separate new update request message for each of the multiple claims. For example, a healthcare provider can implement batch request and response messaging to coordinate patient account data in data store 105 with payor 130, 135 information.

In one embodiment, managing 330 each of the plurality of claims includes creating 310 a batch message for one or more claims. The created batch message requests the status update for each of the claims included in the batch message. Also, the batch includes a batch identifier. For example, in response to the request from the healthcare provider, request module 110 creates batch update message 115, which includes an update request for claims 140, 145, and 150, and further includes a batch identifier 120 that uniquely identifies message 115.

After creating the batch message, the method sends 320 the batch message. Sending 320 the batch message includes sending the batch message to the one or more payors over a network, such that each corresponding payor of the one or more payors receives an electronic request for any of the claims previously received by the corresponding payor. For example, request module 110 sends an identical copy of batch update message 115 to payors 130, 135, etc. Alternatively, request module 110 parses batch update message 115 into individual messages that are unique for each payor, and specifically addressed only to the appropriate payors for the given claims of interest.

After sending the batch message, the practice management system or the request module of the practice management system receives 340 responses from the one or more payors. The practice management system may then forward or provide 350 the responses to the requesting entity such as the health care provider that originated the request for a claim status update. The responses from the payors can be provided to the health care provider in a single electronic message or in multiple electronic messages. The particular format may depend on how and/or when the payors respond to the batch message. After receiving 340 the responses from the payors, the practice management system updates 360 the patient accounts. The updated accounts and/or the responses can be viewed in the user interface 170 as previously described.

FIG. 4 shows that a method in accordance with an implementation of the present invention for updating patient accounts based on communication from one or more banks includes receiving 400 one or more messages from a bank regarding funds. Receiving 400 messages from a bank may include receiving electronic messages from a bank that funds have been added to one or more accounts of a healthcare provider. For example, as shown in FIG. 2, practice management system 100 receives information from bank 200 that indicates that one or more healthcare provider accounts have been updated. The messages includes information regarding specific account information, check or transaction numbers used to fund the accounts, and any other information such as claim remittance information provided by a payor when funding the given account.

In addition, the method includes identifying 410 payor information for the funds. Identifying 410 payor information for the funds that have been added may include identifying the claim remittance identifiers. The practice management system 100 matches payment information for the funds that have been added to a given account with the account holder (e.g., healthcare provider). In at least one aspect, the payment information includes information regarding the payor (e.g., 130, 135) that added/sent the funds to the given healthcare provider account.

FIG. 4 further shows that the method in accordance with the present invention includes identifying 420 corresponding claims by, for example, identifying the pending claims that correspond to the claim remittance identifiers. For example, the practice management system 100 correlates claim remittance information about funds being received from the bank 200, 205 with a corresponding remittance number (or transaction number, etc.) provided for a given claim by a payor in response to a batch update message 115.

Next, the method updates 430 the patient accounts. Updating 430 the patient accounts may include updating the patient accounts that correspond to the pending claims, such that an amount of the funds that have been paid on a claim in a patient account can be identified. For example, practice management system 100 identifies one or more claims 140, 145, 150, etc. that correspond with one or more patient accounts, and which have been paid at least in part by one or more payors 130, 135. The practice management system 100 then updates the given patient account with information that allows a healthcare provider to identify when, from whom, and/or how certain payments have been applied in response to a given claim for services performed for the patient.

Accordingly, the schema and methods shown and/or described herein enable a healthcare provider with a number of different options for efficiently managing a plurality of pending claims with a plurality of patient accounts, payors, funding institutions and so on. For example, a healthcare provider can obtain and manage fairly granular payment and/or claim information that is potentially correlated among a large number of parties. For at least these and other reasons described herein, implementations of the present invention can enable a given healthcare provider to avoid certain administrative inefficiencies, and therefore provide healthcare attention where it may be better suited.

One will appreciate that embodiments of the invention include or are incorporated in computer-readable media having computer-executable instructions or related data structures stored thereon. Examples of computer-readable media or computer program products include the volatile or non-volatile storage media, including but not limited to RAM, ROM, EEPROM, Flash media, CD-ROM, DVD, or other optical or magnetic storage, as well as any corresponding optical or magnetic storage devices, and/or any other media capable of storing electronic computer-executable instructions or related electronic data structures that are capable of being accessed and/or processed by a general purpose or special purpose computerized system. Computer-readable media also encompasses any appropriate combinations of the foregoing.

Computer-executable instructions comprise, for example, general text instructions in the case of scripts, or compiled instructions in the case of compiled program code, and/or relevant data that are read by one or more components of a general purpose or special purpose computerized system. When read, interpreted, and/or executed, these instructions cause one or more processors of the general purpose or special purpose computerized system (or special purpose processing device) to execute a function or group of functions. As such, computer-executable instructions and associated data structures represent an example of program code means for executing the acts or steps of the invention disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

We claim:

1. In a computerized practice management system in a healthcare environment, in which a healthcare provider and one or more payors interact over a network to make or settle claims for service by the healthcare provider, a method of managing claims of the health care provider, the method comprising:
receiving a request for a status update of a plurality of claims being handled by one or more payors, wherein the plurality of claims have not been settled; and
managing each of the plurality of claims simultaneously through one or more batch message requests and responses, wherein the batch message requests and corresponding responses allow a healthcare provider to update multiple claims pending with multiple payors without creating a separate new update request message for each of the multiple claims.

2. The method as recited in claim 1, wherein managing each of the plurality of claims further comprises:
creating a batch message that requests the status update for each of the plurality of claims, the batch message including a batch identifier; and
sending the batch message to the one or more payors over a network, such that each corresponding payor of the one or more payors receives an electronic request for any of the plurality of claims previously received by the corresponding payor.

3. The method as recited in claim 2, further comprising receiving one or more responses from the one or more payors, the one or more responses indicating that a claim status has changed.

4. The method as recited in claim 3, wherein the change in claim status comprises one or more of satisfaction of the claim, contestation of the claim, or payment of the claim.

5. The method as recited in claim 3, further comprising updating one or more patient accounts corresponding to the plurality of claims.

6. The method as recited in claim 2, further comprising receiving a request for a new batch message that includes a new status update request for the plurality of claims, the new batch message including a reference to the batch identifier from the batch message that was sent previously.

7. The method as recited in claim 6, further comprising setting a predetermined recurrence indicator with the new batch message, such that the new batch message can be automatically resent in accordance with the recurrence indicator.

8. The method as recited in claim 6, further comprising sending the new batch message to the one or more payors over a network, such that each corresponding payor of the one or more payors receives an electronic request for any of the plurality of claims previously received by the corresponding payor.

9. The method as recited in claim 8, wherein sending the new batch message comprises sending an identical copy of the new batch message to each of the one or more payors over the network, such that at least one of the one or more payors receives a message for a claim that is pending at the at least one payor and a message for a claim that is not pending at the at least one payor.

10. The method as recited in claim 8, wherein sending the new batch message comprises sending a parsed copy of the new batch message to each of the one or more payors, the parsed copy being specific to claims corresponding to each of the one or more payors.

11. A computer readable medium having computer executable instructions for performing the method of claim 1.

12. In a computerized practice management system in a healthcare environment, in which a healthcare provider, one or more banks, and one or more payors interact over a network to make or settle one or more claims for service by the healthcare provider, a method of managing claims of the healthcare provider and claim payments to the health care provider, the method comprising:
receiving one or more electronic messages from a bank that funds have been added to one or more accounts of a healthcare provider;
identifying payor information for the funds that have been added, wherein the payor information includes one or more claim remittance identifiers;
identifying one or more pending claims that correspond to the one or more claim remittance identifiers; and
updating one or more patient accounts that correspond to the one or more pending claims, such that an amount of the funds that have been paid on a claim in a patient account can be identified.

13. The method as recited in claim 12, wherein the one or more electronic messages oz are received based on a predetermined continuous time interval.

14. The method as recited in claim 12, further comprising correlating the one or more claim remittance identifiers with claim status information received from one or more payors associated with the identified payor information.

15. The method as recited in claim 12, wherein the one or more electronic messages include one or more image files corresponding to one or more checks used to fund the one or more accounts.

16. The method as recited in claim 12, further comprising receiving a request from a healthcare provider regarding the status of a claim.

17. The method as recited in claim 16, further comprising sending one or more images files corresponding to one or more payments used to pay at least a portion of the claim, and an indication that the claim has been one of satisfied or partially satisfied.

18. The method as recited in claim 16, wherein the healthcare provider enters the request through an active server page user interface provided over a network by the practice management system.

19. A method for managing claims of a health care provider that are made to one or more payors, the method comprising:
receiving a request for a status update for one or more claims that are pending with one or more payors;
creating a batch message for each of the one or more claims, wherein the batch message is associated with a batch ID;
sending the batch message to the one or more payors;
receiving a response regarding the one or more claims from the one or more payors;
updating patient accounts associated with the one or more claims based on the response received from the one or more payors.

20. A method as recited in claim 19, wherein receiving a response regarding the one or more claims further comprises providing the response to a health care provider that initiated the request for the status update for the one or more claims.

21. A method as recited in claim 19, wherein sending the batch message to the one or more payors further comprises parsing the batch message into include electronic messages such that each payor only receives an electronic message that includes claims associated with each payor.

22. A method as recited in claim 19, wherein sending the batch message to the one or more payors further comprises sending the batch message such that each payor receives claims associated with other payors.

23. A method as recited in claim 19, further comprising receiving one or more electronic messages from a bank regarding funds that have been deposited to accounts of a health care provider.

24. A method as recited in claim 23, further comprising:
identifying payor information for the funds in the one or more electronic messages, the payor information including remittance information;
identifying particular claims that are associated with the remittance information; and
updating the patient accounts associated with the particular claims to reflect the funds deposited to accounts of the health care provider.

25. A method as recited in claim 24, further comprising matching the remittance information included in the one or more electronic messages received from the bank with remittance information received in the response to identify the particular claims.

26. A computer readable medium having computer executable instructions for performing the method of claim 19.
